(19) United States
(12) Patent Application Publication
(10) Pub. No.: US 2015/0067354 A1
(43) Pub. Date: Mar. 5, 2015

(54) STORAGE MANAGEMENT DEVICE AND STORAGE MANAGEMENT METHOD

(71) Applicant: POWER-ALL NETWORKS LIMITED, Shatin (HK)

(72) Inventor: STEVE LAP WAI HUI, Shatin (HK)

(21) Appl. No.: 14/469,602

(22) Filed: Aug. 27, 2014

(30) Foreign Application Priority Data
Aug. 27, 2013 (CN) 2013103765674

(51) Int. Cl. G06F 12/14; G06F 21/78

(52) U.S. Cl. CPC G06F 12/1408; G06F 21/78; G06F 2221/2141; G06F 2212/1052
USPC 713/193

(57) ABSTRACT

A storage management method includes: verifying an identity of the user in response to a login operation of the user to login a group storage space; determining storage spaces to which the user has access permission according to the identity of the user when the user is an authorized user; obtaining a group secret key of the user group that the user belongs to when the user stores data to a target storage space and encrypting the data by using the group secret key; and storing the encrypted data to the target storage space.

### CROSS-REFERENCE TO RELATED APPLICATIONS

This application claims priority to Chinese Patent Application No. 201310376567.4 filed on Aug. 27, 2013 in the China Intellectual Property Office, the contents of which are incorporated by reference herein.

### FIELD

The present disclosure relates to management devices, and particularly to a storage management device and a method thereof.

### BACKGROUND

Nowadays, some enterprises has a storage server to provided as a public storage device, each member of the enterprise can share data to other members via the public storage device. Usually, the public storage device is established and maintained by the enterprise.

### BRIEF DESCRIPTION OF THE DRAWINGS

Implementations of the present technology will now be described, by way of example only, with reference to the attached figures.

FIG. 1 is a block diagram of a storage management device.

FIG. 2 is a block diagram of a storage management system running in the storage management device.

FIG. 3 is a diagrammatic view of a storage space provided by the storage management device.

FIG. 4 is a flowchart diagram of an embodiment of a storage assignment management method of a storage management method.

FIG. 5 is a flowchart diagram of an embodiment of a storage accessing management method of a storage management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of one embodiment described herein. However, it will be understood by those of ordinary skill in the art that one embodiment described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of one embodiment described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

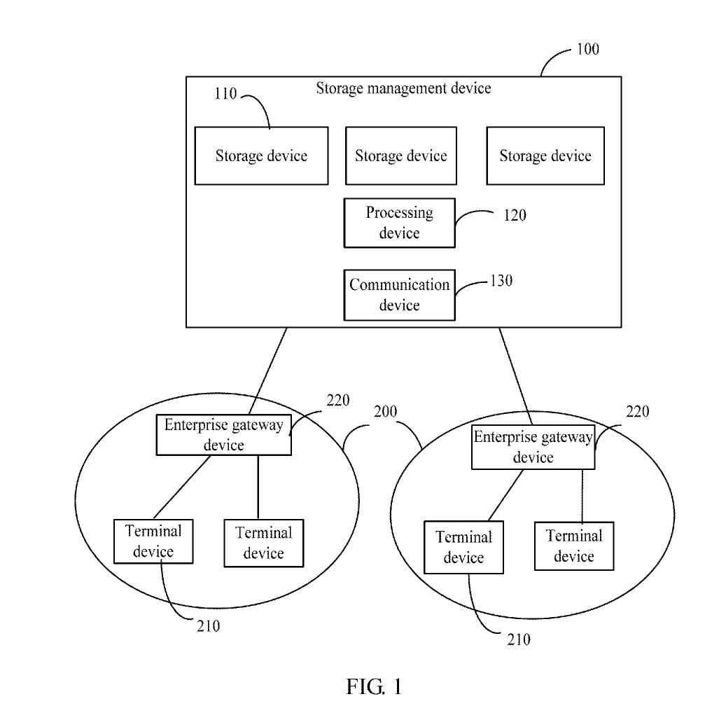

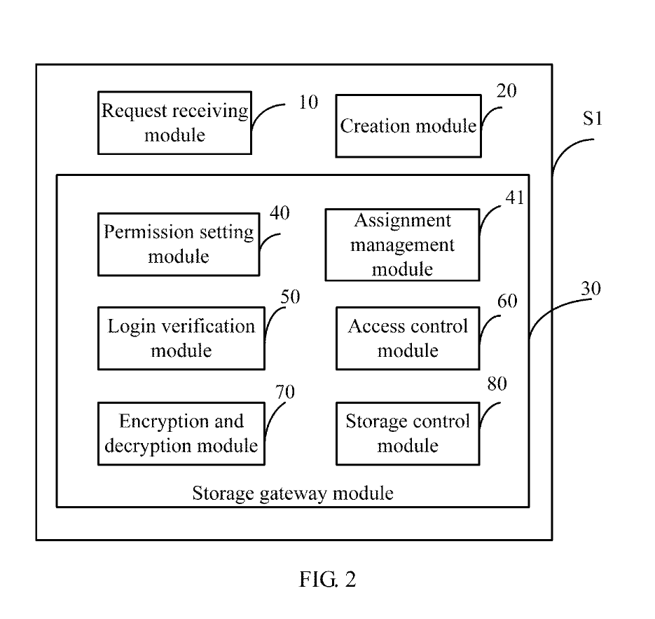

Referring to FIGS. 1 and 2, a storage management device 100 includes a number of storage devices 110, a processing device 120, and a communication device 130. A storage capacity of the storage management device 100 can be increased or decreased according to requirement. In detail, the storage capacity of the storage management device 100 can be increased or decreased by increasing or decreasing an amount of the storage devices 110. The processing device 120 is used to run a storage management system 1. The storage management system 1 to manage a user group 200 to use storage spaces of the storage management device 100 when executing or running the storage management system 1.

In at least one embodiment, each user group 200 includes a number of terminal devices 210 being used by a number of users of the user group 200. The terminal devices 210 can be mobile phones, tablet computers, portable computers, desktop computers, or the like. The user group 200 can be an enterprise, a school/university, or other organizations. The storage management device 100 can a single server or a server group. The storage devices 110 and the processing devices can be located entirely or partially external or internal relative to the storage management device 100.

The storage management device 100 communicates with the terminal devices 210 via the communication device 130. The communication device 130 can communicate via a wired or wireless connection, such as via a wifi or cellular network, or via a local area network or the Internet.

Referring also to FIG. 2, the storage management system 1 includes a request receiving module 10, a creation module 20, and a storage gateway module 30. The modules of the storage management system 1 can be a collection of software instructions stored in the storage device 110 and executed by the processing device 120. In one embodiment, the processing device 120 can be one or more central processing units, one or more digital signal processors, one or more single chips, or a server with processing function. In one embodiment, the storage device 110 can be an internal storage system, such as a flash memory, a random access memory (RAM) for temporary storage of information, and/or a read-only memory (ROM) for permanent storage of information. The storage device 110 can also be a storage system, such as a hard disk, a storage card, or a data storage medium. In at least one embodiment, the storage device 110 can include two or more storage devices such that one storage device is a memory and the other storage device is a hard drive. Additionally, one or more of the storage device 110 can be located external relative to the storage management device 100.

The request receiving module 10 can receive a creation request for creating a group storage space 31 from a user group 200, the creation request can include an identity of the user group 200 and a size of the group storage space 31. The identity of the user group 200 can be an enterprise registration number, unique group identifier, a name or label for the user group 200, or the like. In detail, a user of the user group 200 can access a webpage provided by the storage management device 100, and input information including the identity of the user group 200 and the size of the group storage space 31 to submit the creation request.

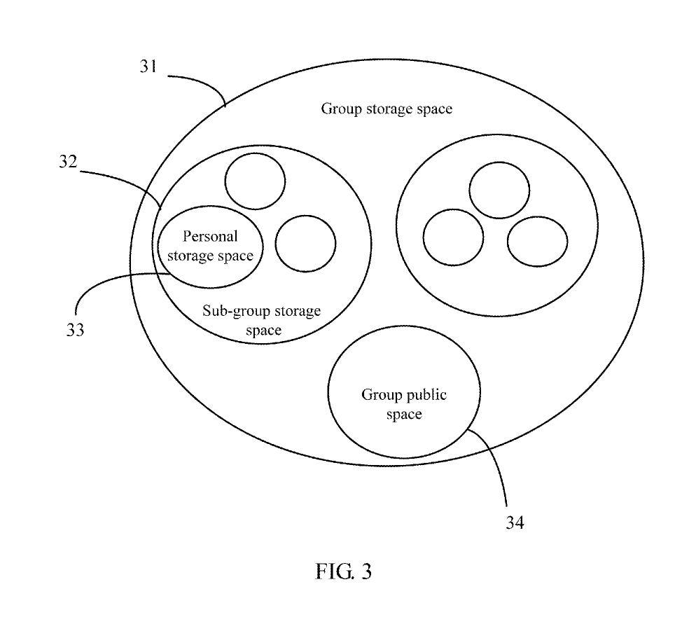

Referring to FIG. 3 together, the creation module 20 can assign a group storage space 31 with the request size from the storage management device 100 to the user group 200 and assign a corresponding storage gateway address to the user group 200. The creation module 20 further associates the group storage space 31 and the corresponding storage gateway address with the identity of the user group 200.

The storage gateway module 30 can control communications between the user group 200 and the storage devices 110 of the storage management device 100, and manage the usage of the storage spaces of the storage devices 110.

In one embodiment, the storage gateway module 30 includes a permission setting module 40 and an assignment management module 41.

The permission setting module 40 can set an administrator identity and permissions of the administrator. In detail, the permission setting module 40 assigns an administrator account, so that a user who logs in via the administrator account is an administrator, and thus sets the administrator identity. The permissions of the administrator set by the permission setting module 40 include, but are not limited to, a permission to create sub-group storage spaces 32, a permission to delete sub-group storage spaces 32, for example.

The assignment management module 41 is used to create or delete sub-group storage spaces 32 and personal storage spaces 33 in the group storage space 31. For example, as shown in FIG. 3, each group storage space 31 can include a number of sub-group storage spaces 32, and each sub-group storage space 32 can include a number of personal storage spaces 33.

In at least one embodiment, the sub-group storage space 32 can be a storage space assigned to a department of an enterprise or a college of a university, for example, or any other actual or logical group of users. The personal storage spaces 33 can be a storage space assigned to a member of the enterprise or a student/teacher of the university, for example.

In at least one embodiment, the permission setting module 40 can further set an access permission of each storage space such as the sub-group storage space 32 and the personal storage space 33. In detail, the assignment management module 41 sets the access permission of the personal storage space 33 as the personal storage space 33 only can be accessed by the corresponding user, and sets the access permission of the sub-group storage space 32 as the sub-group storage space 32 can be accessed by users belong to the corresponding department.

The permission setting module 40 can further establish a group public space 34 in response to an operation of the administrator, and set the access permission of the group public space 34 as the group public space 34 can be accessed by all users of the user group 200.

Therefore, each user can access his/her personal storage space 33, the sub-group storage space 32 corresponding to the department that the user belongs to, and the group public space 34. Therefore, the permission setting module 40 sets the access permission for each user by setting the access permission of each storage space.

In another embodiment, the permission setting module 40 further can change a sub-group storage space 32 that one user can access that space in response to an operation of the administrator. For example, if the user changes to another department, then the permission setting module 40 disables the sub-group storage space 32 corresponding to the previous department to be accessed by the user, and sets the sub-group storage space 32 corresponding to the new department to be accessed by the user.

According to the present disclosure, the user group 200 can utilize the storage source provided by the storage management device 100, and do not need to buy storage servers and maintain the storage servers.

In at least one embodiment, the storage gateway module 30 further includes a login verification module 50, an access control module 60, an encryption and decryption module 70, and a storage control module 80.

The login verification module 50 can verify the identity of the user in response to a login operation of the user. In at least one embodiment, the login verification module 50 verifies the identity of the user via a user account and password input by the user. The login verification module 50 verifies the user is a valid, authorized, or approved user upon determining that the user account and password input by the user are correct.

The access control module 60 can determine to which storage spaces the user has the access permission according to the identity of the user when the login verification module 50 verifies the user is the authorized user, and then manage access for those storage spaces according to the identity and permissions. In detail, the access control module 60 determines the storage spaces to which the user has the access permission according to the access permission of each storage space set by the permission setting module 40. In another embodiment, the identity of each user associates with corresponding permitted storage spaces, the access control module 60 determines the storage spaces corresponding to the identity of the user as the storage spaces the user has the access permission to.

In at least one embodiment, the access control module 60 manages access for the storage spaces as follows: when the access control module 60 determines the storage spaces to which the user has the access permission, the access control module 60 controls to only display the storage spaces to which the user has the access permission when the user logins in the group storage space 31.

In another embodiment, the access control module 60 manages accessing for the storage spaces as follows: the access control module 60 controls to display all of the storage spaces of the group storage space 31 when the user logins in the group storage space 31, and determines whether the user has the access permission to access one storage space when the user request to access the storage space. The access control module 60 further allows the user to access the storage space when the user has access permission to access the storage space, and forbids the user to access the storage space when the user does not have the access permission to access the storage space.

The encryption and decryption module 70 can obtain a group secret key of the user group 200 to which the user belongs when the user stores data to a target storage space of the corresponding group storage space 31 that the user have access permission. The encryption and decryption module 70 then encrypts the data by using the group secret key. In at least one embodiment, the group secret key is associated to the corresponding user group 200 and is taken as the secret key used by all users of the user group 200. In one embodiment, the group secret key is also associated to a storage gateway address of the corresponding storage gateway.

The storage control module 80 can store the encrypted data to the target storage space. For example, when the user stores a file to his or her personal storage space in response to a paste operation, a drag operation, or other file manipulation command, the encryption and decryption module 70 encrypts the file by using the group secret key. The storage control module 80 then stores the encrypted file to the target storage space.

In at least one embodiment, the encryption and decryption module 70 further decrypts the data when the user accesses the data of the storage space for which the user has access permission.

In at least one embodiment, the storage spaces are displayed on the terminal device 210 in icons of disks, files, or the like, when the user logins the group storage space 31 via the terminal device 210.

In at least one embodiment, the data of the personal storage space 33, the group public space 34, and the sub-group storage space 32 are all stored in the group storage space 31 assigned by the storage management device 100. The group storage space 31 is logically divided to different storage spaces, such as the personal storage space 33, the group public space 34, and the sub-group storage space 32. This logical arrangement or grouping can be completely independent of the underlying data storage structure.

In at least one embodiment, the storage gateway address can be a file transfer protocol (FTP) file address, a website address, or the like. The user can input the storage gateway address to enter a login interface of the group storage space 31, the user then can input the user account and the password to login the group storage space 31.

In at least one embodiment, as shown in FIG. 1, each user group 200 further includes an enterprise gateway device 220. All of the terminal devices 210 of one user group 200 are connected to the corresponding enterprise gateway device 220, and then connected to the storage management device 100 via the enterprise gateway device 220.

In at least one embodiment, the creation request received by the request receiving module 10 further includes an enterprise gateway address, the creation module 20 further associates the enterprise gateway address with the storage gateway address and the identity of the user group 200. The login verification module 50 further obtains the enterprise gateway address when the user logins the group storage space 31, and further verifies the identity of the user according to the enterprise gateway address. In details, the login verification module 50 obtains an enterprise gateway address account from the user account and an enterprise gateway address input by the user, and determines whether the two obtained enterprise gateway addresses are the same. The login verification module 50 verifies the user is an authorized user when determining the two enterprise gateway addresses are the same and the user account and the password are correct.

In at least one embodiment, a storage management method includes a storage assignment management method and a storage accessing management method.

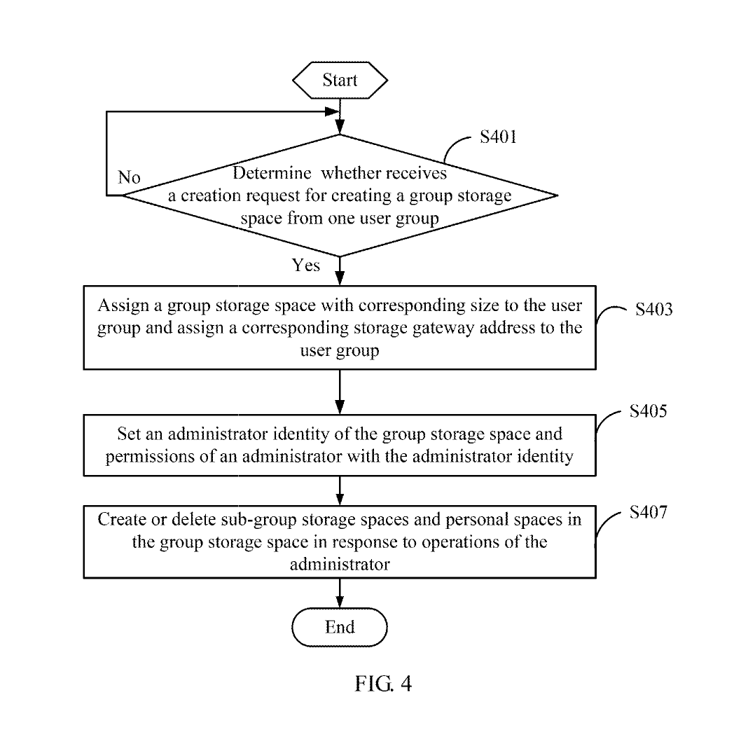

FIG. 4 illustrates a flowchart of the storage assignment management method included in the storage management method.

In block 401, a request receiving module determines whether the request receiving module receives a creation request for creating a group storage space from a user group, the creation request includes an identity of the user group and a request size of the group storage space 31. If yes, the process jumps to block 403, if not, the process returns to block 401.

In block 403, a creation module assigns a group storage space with the request size from the storage management device to the user group and assigns a corresponding storage gateway address to the user group, and further associates the group storage space and the corresponding storage gateway address with the identity of the user group.

In block 405, a permission setting module sets an administrator identity of the group storage space and permissions of an administrator with the administrator identity. In detail, the permission setting module assigns an administrator account, and a user logins via the administrator account is the administrator with the administrator identity, thus to set the administrate identity.

In block 407, an assignment management module creates or deletes sub-group storage spaces and personal storage spaces in the group storage space in response to operations of the administrator.

In at least one embodiment, the storage assignment management method can further include: the permission setting module further changes a sub-group storage space that one user can access in response to an operation of the administrator.

The storage assignment management method can further include: the permission setting module further sets an access permission of each storage space. In detail, the assignment management module sets the access permission of the personal storage space as only can be accessed by the corresponding user, and sets the access permission of the sub-group storage space as can be accessed by users belongs to the corresponding department.

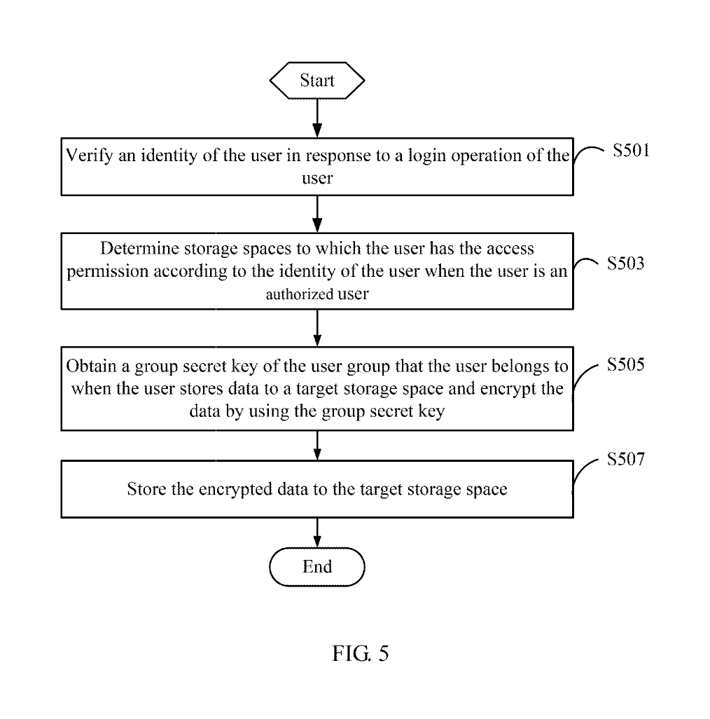

FIG. 5 is a flowchart diagram of an embodiment of the storage accessing management method included in the storage management method.

In block 501, a login verification module verifies an identity of a user in response to a login operation of the user. In detail, the login verification module verifies the identity of the user via a user account and a password input by the user, and verifies the user is an authorized user when determining the user account and the password input by the user are correctly

In block 503, an access control module determines to which storage spaces the user has the access permission according to the identity of the user when the login verification module verifies the user is the authorized user.

In block 505, an encryption and decryption module obtains a group secret key of the user group that the user belongs to when the user stores data to a target storage space of the corresponding group storage space that the user has access permission.

In block 507, a storage control module stores the encrypted data to the target storage space.

The storage accessing management method can further include: the encryption and decryption module further decrypts data according to the group secret key when the user accesses the data of the storage space for which the user has access permission. The group secret key can be any suitable cryptographic key, and can be based on biometrics, cryptographic cards, or passwords, for example. The group secret key can be a symmetric or an asymmetric key, and can be part of a key scheme in which individual users have distinct keys that provide access to respective resources, while the group secret key provides access to resources for the entire group, for example.

The storage accessing management method can further include: the access control module controls to only display the storage spaces that the user has the access permission to when the user logins in the group storage space.

The storage accessing management method can further include: the access control module controls to display all of the storage spaces of the group storage space when the user logins in the group storage space, and determines whether the user has the access permission to access one storage space when the user request to access the storage space; the access control module then allows the user to access the storage space when the user have the access permission to access the storage space, and forbids the user to access the storage space when the user does not have the access permission to access the storage space.

In another embodiment, in the block 401, the creation request received by the request receiving module further includes an enterprise gateway address; in the block 403, the creation module further associates the enterprise gateway address with the storage gateway address and the identity of the user group. In the block 501, the login verification module further obtains the enterprise gateway address when the user logins the group storage space, and further verifies the identity of the user according to the enterprise gateway address. In details, the login verification module obtains an enterprise gateway address from the user account and an enterprise gateway address input by the user, and determines whether the two obtained enterprise gateway addresses are the same; the login verification module verifies the user is the authorized user when determining the two enterprise gateway addresses are the same and the user account and the password are correctly.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A storage management device comprising:
A communication unit configured to connect to at least one terminal device of a user of a user group;
a plurality of storage devices, one or more of the plurality of storage devices storing a plurality of modules which are collection of instructions; and
at least one processing device configured to execute the plurality of modules which are collection of instructions, the modules comprising:
a login verification module configured to verify the identity of the user in response to a login operation of the user to login a group storage space;
an access control module configured to determine storage spaces to which the user has access permission according to the identity of the user when the login verification module verifies the user is an authorized user;
an encryption and decryption module configured to obtain a group secret key of the user group that the user belongs to when the user stores data to a target storage space and encrypt the data by using the group secret key; and
a storage control module configured to store the encrypted data to the target storage space.

2. The device according to claim 1, wherein the encryption and decryption module is further configured to decrypt data according to the group secret key when the user accesses the data of the storage space to which the user has access permission.

3. The device according to claim 1, wherein the access control module is further configured to control to only display the storage spaces that the user has the access permission to when the user logins in the group storage space.

4. The device according to claim 1, wherein the access control module is further configured to controls to display all of the storage spaces of the group storage space when the user logins in the group storage space, and determine whether the user has the access permission to access one storage space when the user request to access the storage space; the access control module is further configured to allow the user to access the storage space when the user have the access permission to access the storage space, and forbid the user to access the storage space when the user does not have the access permission to access the storage space.

5. The device according to claim 1, wherein the modules further comprises a permission setting module configured to set an access permission of each storage space.

6. The device according to claim 1, wherein the identity of each user associates with corresponding permitted storage spaces, the access control module determines the storage spaces corresponding to the identity of the user as the storage spaces to which the user has access permission.

7. The device according to claim 1, wherein the login verification module obtains an enterprise gateway address account from a user account and an enterprise gateway address input by the user when the user logins the group storage space, and verifies the user is the authorized user when determining the two enterprise gateway addresses are the same and the user account and a password input by the user are correct.

8. A storage management method comprising:
verifying an identity of the user in response to a login operation of the user to login a group storage space;
determining storage spaces to which the user has access permission according to the identity of the user when the user is an authorized user;
obtaining a group secret key of the user group that the user belongs to when the user stores data to a target storage space and encrypting the data by using the group secret key; and
storing the encrypted data to the target storage space.

9. The method according to claim 8, further comprising:
decrypting data according to the group secret key when the user accesses the data of the storage space to which the user has access permission.

10. The method according to claim 8, further comprising:
controlling to only display the storage spaces that the user has the access permission to when the user logins in the group storage space.

11. The method according to claim 8, further comprising:
controlling to display all of the storage spaces of the group storage space when the user logins in the group storage space;
determining whether the user has the access permission to access one storage space when the user request to access the storage space;
allowing the user to access the storage space when the user have the access permission to access the storage space; and
forbidding the user to access the storage space when the user does not have the access permission to access the storage space.

12. The method according to claim 8, further comprising:
setting an access permission of each storage space.

13. The method according to claim 1, wherein the identity of each user associates with corresponding permitted storage spaces, the step of determining storage spaces to which the user has access permission according to the identity of the user when the user is an authorized user comprises:
determining the storage spaces corresponding to the identity of the user as the storage spaces to which the user has access permission.

14. The method according to claim 1, wherein the step of verifying an identity of the user in response to a login operation of the user to login a group storage space comprises:
obtaining an enterprise gateway address account from a user account and an enterprise gateway address input by the user when the user executes the login operation; and
verifying the user is the authorized user when determining the two enterprise gateway addresses are the same and the user account and a password input by the user are correct.

15. A non-transitory storage medium having stored thereon instructions that, when executed by at least one processor, causes the least one processor to execute instructions of a method for automatically managing storage spaces, the method comprising:
verifying an identity of the user in response to a login operation of the user to login a group storage space;
determining storage spaces to which the user has access permission according to the identity of the user when the user is an authorized user;
obtaining a group secret key of the user group that the user belongs to when the user stores data to a target storage space and encrypting the data by using the group secret key; and
storing the encrypted data to the target storage space.

16. The non-transitory storage medium according to claim 15, wherein the method further comprising:
decrypting data according to the group secret key when the user accesses the data of the storage space to which the user has access permission.

17. The non-transitory storage medium according to claim 15, wherein the method further comprising:
controlling to only display the storage spaces that the user has the access permission to when the user logins in the group storage space.

18. The non-transitory storage medium according to claim 15, wherein the method further comprising:
controlling to display all of the storage spaces of the group storage space when the user logins in the group storage space;
determining whether the user has the access permission to access one storage space when the user request to access the storage space;
allowing the user to access the storage space when the user have the access permission to access the storage space; and
forbidding the user to access the storage space when the user does not have the access permission to access the storage space.

19. The non-transitory storage medium according to claim 15, wherein the identity of each user associates with corresponding permitted storage spaces, the step of determining storage spaces to which the user has access permission according to the identity of the user when the user is an authorized user comprises:
determining the storage spaces corresponding to the identity of the user as the storage spaces to which the user has access permission.

20. The non-transitory storage medium according to claim 15, wherein the step of verifying an identity of the user in response to a login operation of the user to login a group storage space comprises:
obtaining an enterprise gateway address account from a user account and an enterprise gateway address input by the user when the user executes the login operation; and
verifying the user is the authorized user when determining the two enterprise gateway addresses are the same and the user account and a password input by the user are correct.
